(19) United States
(12) Patent Application Publication
(10) Pub. No.: US 2003/0125959 A1
(43) Pub. Date: Jul. 3, 2003

(54) Translation device with planar microphone array

(76) Inventor: Robert D. Palmquist, Faribault, MN (US)

Correspondence Address: SHUMAKER & SIEFFERT, P. A., 8425 SEASONS PARKWAY, SUITE 105, ST. PAUL, MN, 55125, US

(21) Appl. No.: 10/234,085

(22) Filed: Aug. 30, 2002

Related U.S. Application Data
(60) Provisional application No. 60/346,179, filed on Dec. 31, 2001.

(51) Int. Cl. G10L 11/00

(52) U.S. Cl. 704/277

(57) ABSTRACT

Embodiments of the invention include a device and a method for translating words spoken in one language to a graphic or audible version of the words in a second language. A planar array of three or more microphones may be placed on a portable device, such as a handheld computer or a personal digital assistant. The planar array, in conjunction with a signal processing circuit, defines a direction of sensitivity. In a noisy environment, spoken words originating from the direction of sensitivity are selected and other sounds are rejected. The spoken words are recognized and translated, and the translation is displayed on a display screen and/or issued via a speaker.

This application claims priority from U.S. Provisional Application Serial No. 60/346,179, filed Dec. 31, 2001, the entire content of which is incorporated herein by reference.

### TECHNICAL FIELD

The invention relates to electronic detection of audible communication, and more particularly, to electronic sensing of the human voice.

### BACKGROUND

The need for real-time language translation has become increasingly important. It is becoming more common for a person to encounter an environment in which an unfamiliar foreign language is spoken or written. Trade with a foreign company, cooperation of forces in a multi-national military operation in a foreign land, emigration and tourism are just some examples of situations that bring people in contact with languages with which they may be unfamiliar.

In some circumstances, the language barrier presents a very difficult problem. A person may not know enough of the local language to be able to obtain assistance with a problem or ask for directions or order a meal. The person may wish to use any of a number of commercially available translation systems. Some such systems require the person to enter the word or phrase to be translated manually, which is time consuming and inconvenient. Other systems allow the person to enter the word or phrase to be translated audibly, but local noise may interfere with the translation.

### SUMMARY

In general, the invention provides techniques for translation of spoken languages. In particular, the invention provides techniques for selecting a spoken language from a noisy environment with a planar array of three or more microphones. The planar array of microphones, in conjunction with a signal processing circuit, defines a direction of sensitivity. Sounds originating from the direction of sensitivity are selected, and sounds originating from outside the direction of sensitivity are rejected. The selected sounds are analyzed to recognize a voice speaking words in a first language. The recognized words are translated to a second language. The translation is displayed on a display screen, audibly issued by an audio output device such as a speaker, or both.

In one embodiment, the invention presents a device comprising at least three microphones defining a plane, with each microphone generating a signal in response to a sound. The device further comprises a signal processing circuit that processes the signals to select the signals when the sound originates from a direction of sensitivity and to reject the signals when the sound originates from outside the direction of sensitivity. The sound may be a voice speaking words in a first language from the direction of sensitivity. The device includes a display that displays a graphic version of the words in a second language, and/or an audio output circuit that generates an audible version of the words in the second language. The device may further comprise a voice recognizer that converts the sound of the voice to the first language and a language translator that translates the first language to the second language.

In another embodiment, the invention is directed to a method comprising receiving a sound and selecting the sound when the sound originates from a direction of sensitivity as defined by at least three microphones defining a plane. The method also includes extracting spoken words in a first language from the selected sound. The method further includes generating a graphic version of the words in a second language, and/or generating an audible version of the words in the second language.

In an additional embodiment, the invention presents a device comprising at least three microphones defining a plane, with each microphone generating a signal in response to a sound. The device also includes a signal processing circuit that selects the signals when the sound originates from a direction of sensitivity and rejects the signals when the sound originates from outside the direction of sensitivity. The device further comprises a language translator that, when the sound includes a voice speaking words in a first language from the direction of sensitivity, generates a version of the words in a second language.

In a further embodiment, the invention is directed to a method comprising receiving a sound, selecting the sound when the sound originates from a direction of sensitivity as defined by at least three microphones defining a plane, extracting spoken words in a first language from the selected sound and translating the words in the first language to a second language. The translation may be presented visibly and/or audibly.

The invention may offer one or more advantages, including portability and multilanguage capability. The invention may be used in noisy environments. The planar array of microphones and signal processing circuitry spatially filter extraneous noise, and select the sounds that include the words needing translation. In addition, integration of the planar array of microphones with a display device and/or an audio output device enables prompt and convenient feedback to be delivered to the user.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG 1 is a perspective drawing of an embodiment of the invention, with a user and a noise source.

FIG. 2 is a perspective drawing of an embodiment of the invention in use.

FIG. 3 is a block diagram illustrating an embodiment of the invention.

FIG. 4 is a flow diagram illustrating interaction between a user and a device embodying the invention.

### DETAILED DESCRIPTION

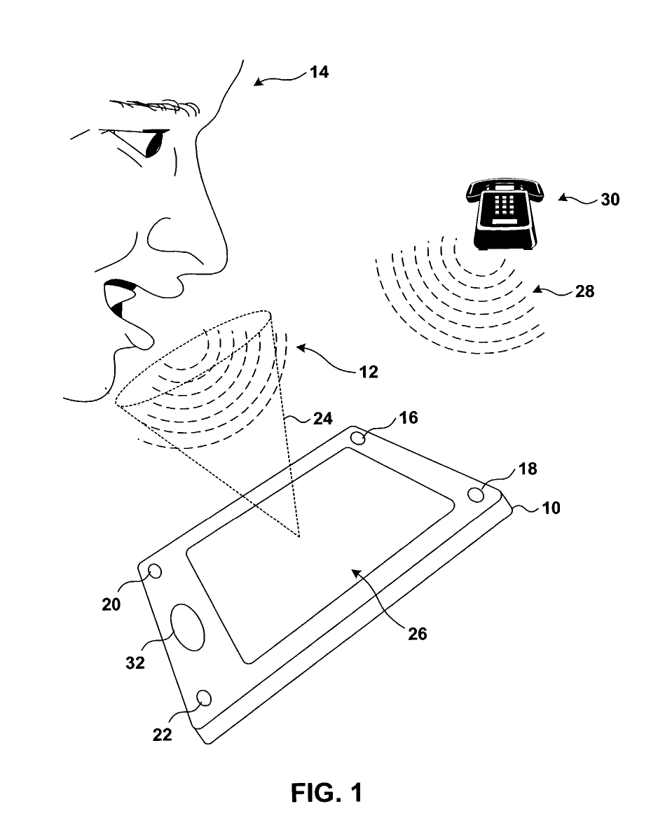

FIG 1 is a perspective drawing of a translating device 10, which receives audio input 12 from a user 14. The audio input 12 includes words spoken in a “source language,” which is usually a language with which user 14 is familiar. If the user is a native speaker of English, for example, the source language may be English. Translating device 10 receives audio input 12 via microphones 16, 18, 20 and 22. As will be described in more detail below, microphones 16, 18, 20 and 22 form an array that selects sounds originating from a direction of sensitivity, represented by cone-like volume 24, and reject sounds originating from directions outside direction of sensitivity 24.

Translating device 10 may, as depicted in FIG. 1, be a handheld device, such as a handheld computer or a personal digital assistant (PDA). In the embodiment depicted in FIG. 1, translating device 10 includes four microphones 16, 18, 20 and 22 arrayed in the corners of device 10 in a rectangular pattern, but this configuration is exemplary. Comer placement may be advantageous for a handheld device because user 14 may prefer to hold the device in the center along the outer edges of the device and thus be less likely to cover a microphone placed in a comer.

Translating device 10 includes at least three microphones, which define a plane. In alternate embodiments, translating device 10 may include any number of microphones in any pattern, but in general the microphones are planar and are spaced apart at known distances so that the array can select sounds originating from direction of sensitivity 24 and reject sounds originating from directions outside direction of sensitivity 24.

In some embodiments, translating device 10 includes a display screen 26. Display screen 26 may be oriented within the same plane occupied by microphones 16, 18, 20 and 22. If display screen 26 and microphones 16, 18, 20, 22 are co-planar, user 14 may find it intuitive to “speak into the display,” in effect, and thereby direct speech within direction of sensitivity 24.

Translating device 10 may include an audio output circuit that includes an audio output device such as speaker 32. Speaker 32 may be provided in addition to, or as an alternative to, display screen 26. Speaker 32 may be oriented within the same plane occupied by microphones 16, 18, 20 and 22. Speaker 32 may also be positioned such that user 14 may find it intuitive to “talk to the speaker,” thereby directing speech within direction of sensitivity 24.

Microphones 16, 18, 20 and 22 may be, for example, omnidirectional microphones. Direction of sensitivity 24 may be defined by a signal processing circuit (not shown in FIG. 1) that processes the signals from microphones 16, 18, 20 and 22 according to any of several techniques for spatial filtering. In one technique, for example, sound originating from direction of sensitivity 24, such as audio input 12, arrives at microphones 16, 18, 20 and 22 nearly simultaneously, and accordingly the signals generated by microphones 16, 18, 20 and 22 in response to such a sound are nearly in phase. Noise 28 from a noise source 30, by contrast, arrives at microphones 16, 18, 20 and 22 at different times, resulting in a phase shift. By comparing the phase differences between or among signals generated by different microphones, translating device 10 can select those sounds that originate from direction of sensitivity 24, and can reject those sounds that originate from outside direction of sensitivity 24.

Microphones 16, 18, 20 and 22 may be also be directional microphones that are physically constructed to be more sensitive to sounds originating from direction of sensitivity 24. Direction of sensitivity 24 may therefore be a function of the physical characteristics of microphones 16, 18, 20 and 22. In addition, direction of sensitivity 24 may be a function of the spatial filtering functions of the signal processing circuit and the physical characteristics of the microphones.

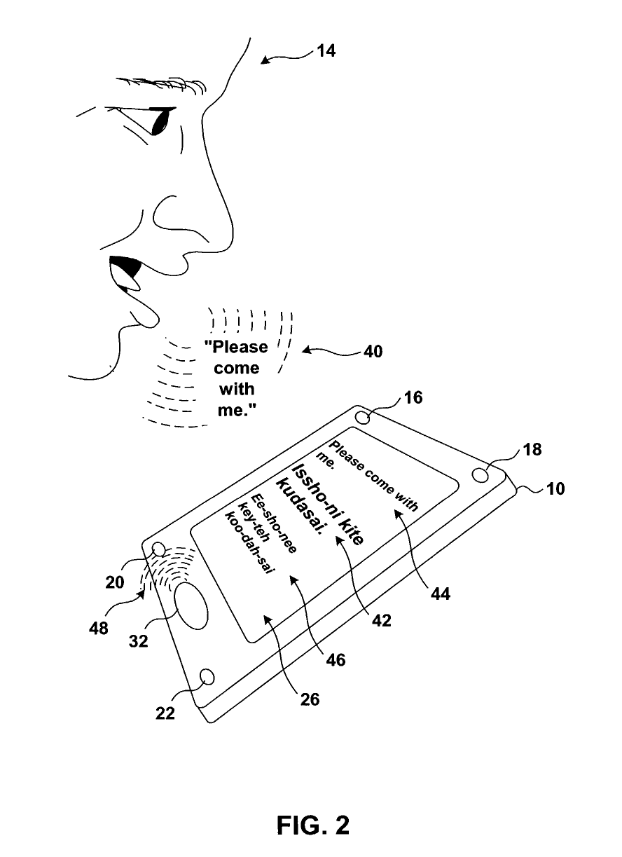

FIG. 2 is a perspective drawing of a translating device 10 in an ordinary application. User 14 utters a word, phrase or sentence 40 in the source language. Utterance 40 is within direction of sensitivity 24. Translating device 10 receives utterance 40 and produces a graphic translation 42 of utterance 40 on display screen 26. Graphic translation 42 is in a “target language,” which is a language with which user 14 is usually unfamiliar. The translation is “graphic” in that the translation may be displayed in any visual form, using any appropriate alphabet, symbols or character sets, or any combination thereof.

In addition to graphic translation 42, translating device 10 may display other data on screen 26, such as a graphic version 44 of utterance 40. Graphic version 44 echoes spoken utterance 40, and user 14 may consult graphic version 44 to see whether translating device 10 has correctly understood utterance 40. Translating device 10 may also supply other information, such as a phonetic pronunciation 46 of graphic translation 42, or a representation of the translation in the character set of the target language.

In addition to or as an alternative to graphic translation 42, translating device 10 may supply an audio version 48 of the translation of utterance 40. Translating device 10 may include speech synthesis capability, allowing the translation to be issued audibly via speaker 32. Furthermore, translating device 10 may repeat utterance 40 back to user 14 with synthesized speech via speaker 32, so that user 14 may determine whether translating device 10 has correctly understood utterance 40.

Translating device 10 may translate from a language with which user 14 is unfamiliar to a language with which user 14 is familiar. In one exemplary application, user 14 may be able to speak the source language but not comprehend it, such as when a word or phrase is written phonetically. Some languages, such as Spanish or Japanese kana, are written phonetically. Translating device 10 may receive the words spoken by user 14 in an unfamiliar language and display or audibly issue a translation in a more familiar language. In another exemplary application, user 14 may hold a conversation with a speaker of the language unfamiliar to user 14. The parties to the conversation may alternate speaking to translating device 10, which serves as an interpreter for both sides of the conversation.

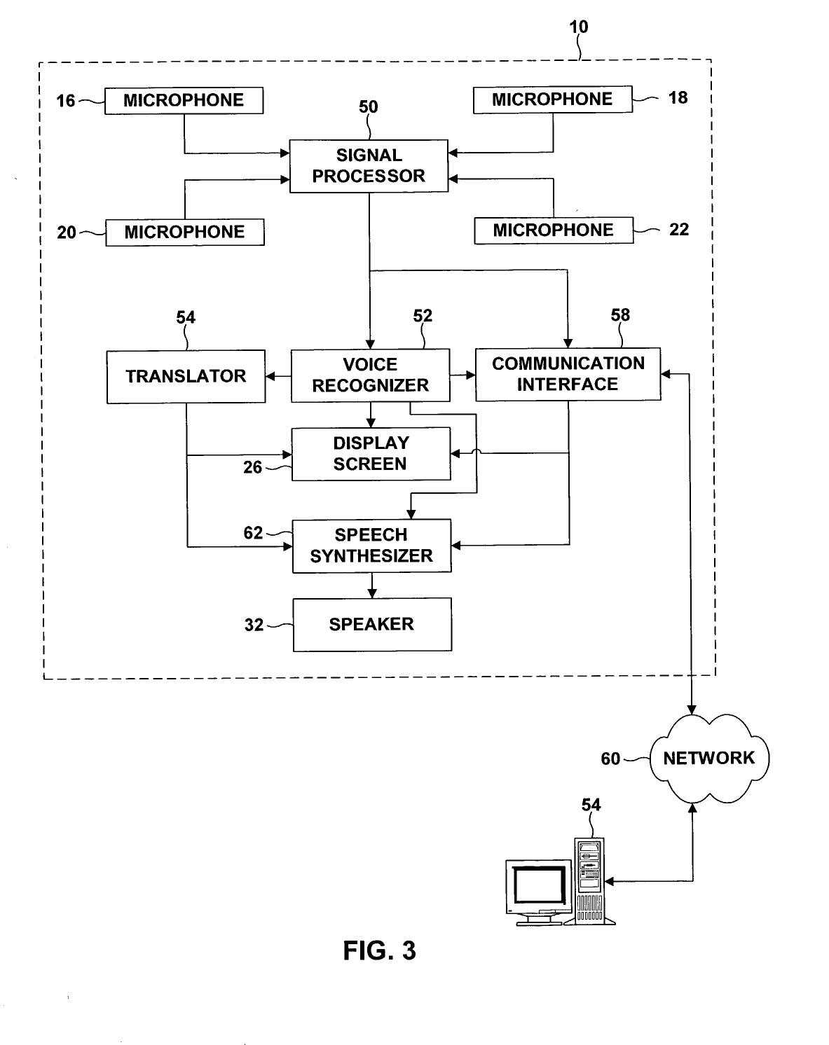

FIG. 3 is a block diagram illustrating an embodiment of the invention. Microphones 16, 18, 20 and 22 supply signals to signal processing circuit 50. Signal processing circuit 50 spatially filters the signals to select sounds from direction of sensitivity 24 and reject sounds from outside direction of sensitivity 24. Although microphones 16, 18, 20 and 22 may detect several distinct sounds, signal processing circuit 50 selects which sounds will be subjected to further processing.

In addition to selecting the sounds for further processing, signal processing circuit 50 may perform other functions, such as amplifying the signals of selected sounds and filtering undesirable frequency components. Signal processing circuit 50 may include circuitry that processes the signals with analog techniques, circuitry that processes the signals digitally, or circuitry that uses a combination of analog and digital techniques. Signal processing circuit 50 may further include an analog-to-digital converter that converts analog signals to digital signals for digital processing.

Selected sounds may be supplied to a voice recognizer 52 such as a voice recognition circuit. Voice recognizer 52 interprets the selected sounds and extracts spoken words in the source language from the sounds. The extracted words may be presented on display screen 26 to user 14, and user 14 may determine whether translating device 10 has correctly extracted the words spoken. The extracted words may also be supplied to a speech synthesizer 62, which repeats the words via speaker 32. Voice recognition and speech synthesis software and/or hardware for different source languages may be commercially available from several different companies.

The extracted words may be supplied to a translator 54, which translates the words spoken in the source language to the target language. Translator 54 may employ any of a variety of translation programs. Different companies may make commercially available translation programs for different target languages. The translation may be presented on display screen 26 to user 14, or may be supplied to speech synthesizer 62 and audibly issued by speaker 32 as synthesized speech. Translator 54 may also provide additional information, such as phonetic pronunciation 46, for presentation via display screen 26 or speaker 32.

As shown in FIG. 3, voice recognizer 52 and translator 54 are included in translating device 10. The invention also encompasses embodiments in which voice recognition and/or translation are performed remotely. Instead of supplying selected sounds to an on-board voice recognizer 52, translating device 10 may supply information representative of the selected sounds to a server 56 via a communication interface 58 and a network 60. Server 56 may perform voice recognition and/or translation and supply the translation to translating device 10. Communication interface 58 may include, for example, a cellular telephone or an integrated wireless transceiver. Network 60 may include, for example, a wireless telecommunication network such as a network implementing Bluetooth, a cellular telephone network, the public switched telephone network, an integrated digital services network, satellite network or the Internet, or any combination thereof.

Voice recognition and translation, whether performed by translating device 10 or by server 56, need not be limited to a single source language and a single target language. Translating device 10 may be configured to receive multiple source languages and to translate to multiple target languages.

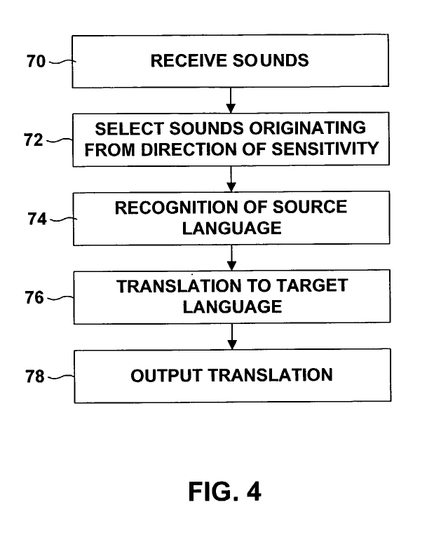

FIG. 4 is a flow diagram illustrating an embodiment of the invention. Translating device 10 receives sounds (70) via microphones 16, 18, 20 and 22. Signal processing circuit 50 selects the sounds from direction of sensitivity 24 for further processing (72). A voice recognizer 52, such as voice recognition circuit, interprets the selected sounds and extracts spoken words in the source language from the sounds (74). A translator 54 translates the words in the source language to words in the target language (76). Display screen 26 displays the translation, or speaker 32 audibly issues the translation, or both (78).

The invention can provide one or more advantages. Translating device 10 may be small, lightweight and portable. Portability allows travelers, such as tourists, to be more mobile, to see sights and to obtain translations as desired. In addition, the invention may have a multi-language capability, and need not be customized to any particular language. The user may also have the choice of using on-board voice recognition and translation capabilities, or using voice recognition and translation capabilities of a remote or nearby server. In some circumstances, a server may provide more fully-featured voice recognition and translation capability.

The invention may be used in a variety of noisy environments. The planar array of microphones and signal processing circuitry define a direction of sensitivity that selects sounds originating from the direction of sensitivity and rejects sounds originating from outside the direction of sensitivity. This spatial filtering improves voice recognition by removing interference caused by extraneous noise in the environment. The user need not wear a microphone in a headset or other cumbersome apparatus.

Several embodiments of the invention have been described. Various modifications may be made without departing from the scope of the invention. For example, translating device 10 may include other input/output devices, such as a keyboard, mouse, touch pad, stylus or push buttons. A user may employ any of these input/output devices for several purposes. For example, when translating device 10 displays a graphic version 44 of the words uttered by the user, the user may employ an input/output device to correct errors in graphic version 44. The user may also employ an input/output device to configure translation device 10, such as by selecting a source language or target language, or by programming signal processor 50 to establish the dimensions and orientation of direction of sensitivity cone 24. Translating device 10 may also include an audio output device in addition to or other than a speaker, such as a jack for an earphone. These and other embodiments are within the scope of the following claims.

1. A device comprising:
at least three microphones defining a plane, each microphone generating a signal in response to a sound;
a signal processing circuit that processes the signals to select the signals when the sound originates from a direction of sensitivity and to reject the signals when the sound originates from outside the direction of sensitivity; and
a display that, when the sound includes a voice speaking words in a first language from the direction of sensitivity, displays a graphic version of the words in a second language.

2. The device of claim 1, wherein the display displays a graphic version of the words in the first language when the sound is the voice speaking words in the first language.

3. The device of claim 1, further comprising a voice recognizer that extracts the words in the first language from the sound.

4. The device of claim 1, further comprising a language translator that translates the first language to the second language.

5. The device of claim 1, wherein the device is handheld.

6. The device of claim 1, wherein the signal processing circuit comprises a spatial filter.

7. The device of claim 1, wherein the microphones comprise directional microphones.

8. The device of claim 1, wherein the direction of sensitivity comprises a directional cone-like volume.

9. The device of claim 1, further comprising a communication interface that transmits one of the sound and the words spoken in the first language to a server.

10. A method comprising:
receiving a sound;
selecting the sound when the sound originates from a direction of sensitivity as defined by at least three microphones defining a plane;
extracting spoken words in a first language from the selected sound; and
generating at least one of a graphic version and an audible version of the words in a second language.

11. The method of claim 10, further comprising translating the words in the first language to the second language.

12. The method of claim 10, wherein the direction of sensitivity is further defined by a signal processing circuit.

13. The method of claim 10, further comprising displaying a graphic version of the words in the first language.

14. The method of claim 10, further comprising audibly issuing a version of the words in the first language with synthesized speech.

15. The method of claim 10, further comprising rejecting the sound when the sound originates from outside the direction of sensitivity.

16. A device comprising:
at least three microphones defining a plane, each microphone generating a signal in response to a sound;
a signal processing circuit that processes the signals to select the signals when the sound originates from a direction of sensitivity and to reject the signals when the sound originates from outside the direction of sensitivity; and
an audio output circuit that, when the sound includes a voice speaking words in a first language from the direction of sensitivity, generates an audible version of the words in a second language.

17. The device of claim 16, wherein the audio output circuit comprises a speaker.

18. The device of claim 16, wherein the audio output circuit comprises a speech synthesizer.

19. The device of claim 16, wherein the audio output circuit generates an audible version of the words in the first language when the sound is the voice speaking words in the first language.

20. The device of claim 16, further comprising a voice recognizer that extracts the words in the first language from the sound.

21. The device of claim 16, further comprising a language translator that translates the first language to the second language.

22. The device of claim 16, wherein the device is handheld.

23. The device of claim 16, wherein the signal processing circuit comprises a spatial filter.

24. The device of claim 16, wherein the microphones comprise directional microphones.

25. The device of claim 16, wherein the direction of sensitivity comprises a directional cone-like volume.

26. The device of claim 16, further comprising a communication interface that transmits one of the sound and the words spoken in the first language to a server.

27. A device comprising:
at least three microphones defining a plane, each microphone generating a signal in response to a sound;
a signal processing circuit that processes the signals to select the signals when the sound originates from a direction of sensitivity and to reject the signals when the sound originates from outside the direction of sensitivity; and
a language translator that, when the sound includes a voice speaking words in a first language from the direction of sensitivity, generates a version of the words in a second language.

28. The device of claim 27, further comprising a voice recognizer that extracts the words in the first language from the sound.

29. The device of claim 27, wherein the device is handheld.

30. The device of claim 27, wherein the signal processing circuit comprises a spatial filter.

31. The device of claim 27, wherein the microphones comprise directional microphones.

32. The device of claim 27, wherein the direction of sensitivity comprises a directional cone-like volume.

33. The device of claim 27, further comprising a communication interface that transmits one of the sound and the words spoken in the first language to a server.

34. A method comprising:
receiving a sound;
selecting the sound when the sound originates from a direction of sensitivity as defined by at least three microphones defining a plane;
extracting spoken words in a first language from the selected sound; and
translating the words in the first language to a second language.

35. The method of claim 34, wherein the direction of sensitivity is further defined by a signal processing circuit.

36. The method of claim 34, further comprising rejecting the sound when the sound is outside the direction of sensitivity.

37. The method of claim 34, further comprising displaying a graphic version of the words in the first language.

38. The method of claim 34, further comprising generating at least one of a graphic version and an audible version of the words in the second language.
